(19) United States
(12) Patent Application Publication
(10) Pub. No.: US 2007/0049485 A1
(43) Pub. Date: Mar. 1, 2007

(54) Inorganic dielectric powder for composite dielectric material and composite dielectric material

(76) Inventors: Shinji Tanabe, Tokyo (JP); Naoaki Narishige, Tokyo (JP)

Correspondence Address: SMITH PATENT OFFICE, 1901 PENNSYLVANIA AVENUE N W, SUITE 901, WASHINGTON, DC, 20006, US

(21) Appl. No.: 10/592,432

(22) PCT Filed: Mar. 28, 2005
(86) PCT No.: PCT/JP05/05714

§ 371 Date: Sep. 11, 2006

(30) Foreign Application Priority Data
Mar. 29, 2004 (JP) 2004-095371

(51) Int. Cl. C04B 35/465

(52) U.S. Cl. 501/136; 524/413

(57) ABSTRACT

It is an object of the present invention to provide an inorganic dielectric powder used for a composite dielectric material, the inorganic dielectric powder having high filling properties and expressing a high dielectric constant when used as a composite dielectric. It is another object of the present invention to provide a composite dielectric material having a high dielectric constant, the composite dielectric material being used for dielectric layers of electronic components, such as printed circuit boards, semiconductor packages, capacitors, antennae for radio frequencies, and inorganic electroluminescent devices. In an inorganic dielectric powder according to the present invention used for a composite dielectric material mainly containing a polymeric material and the inorganic dielectric powder, the inorganic dielectric powder includes perovskite compound oxide particles in which a subcomponent element is dissolved in barium titanate particles, wherein the perovskite compound oxide particles are prepared by wet-reaction of a titanium compound and a barium compound with a compound containing the subcomponent element and then calcining the resulting reaction product.

### TECHNICAL FIELD

The present invention relates to an inorganic dielectric powder used for a composite dielectric material mainly containing a polymeric material and the inorganic dielectric powder and a composite dielectric material containing the inorganic dielectric powder.

### BACKGROUND ART

To achieve reductions in size and thickness and an increase in density, multilayer printed circuit boards have been becoming more often used as printed circuit boards. Providing high-dielectric layers serving as inner layers or surface layers of the multilayer printed circuit boards improves packing density, thus resulting in further reductions in size and thickness and the increase in density of electronic devices.

Known high-dielectric components are formed of ceramic sinters prepared by forming ceramic powders into a compact and firing the resulting compact. Thus, the dimensions and shapes are limited to forming processes. Furthermore, the sinters have high hardness and brittleness; hence, it is difficult to desirably process the sinters. Thus, it is significantly difficult to form a desirable shape or a complex shape.

Accordingly, composite dielectrics containing inorganic dielectric particles dispersed in resins have attracted attention. It has been proposed to use perovskite compound oxide powders or the like as high-dielectric inorganic powders for use in the composite dielectrics.

It is proposed to use sintered ceramics composed of the perovskite compound oxides (for example, see Patent Documents 1 to 3). However, sintered particles are hard. Thus, it is difficult to perform secondary processing. Furthermore, since the particles are coarse, there is a problem of filling properties.

In addition, the following methods are also proposed: a method of using particles composed of barium titanate or the like, the surface of each of the particles being partially or completely covered with a conductive metal, an organic compound, or a conductive inorganic oxide (for example, see Patent Documents 4 and 5; and a method of using barium titanate material prepared by firing a mixture of a barium titanate powder and a compound powder containing a subcomponent element at a temperature in the range of 1,100° C. to 1,450° C. for 10 minutes or more (for example, see Patent Document 6). However, the development of an inorganic dielectric for a composite dielectric, the inorganic dielectric having satisfactory filling properties and a high dielectric constant when used as a composite dielectric, is required.

Patent Document 1: Japanese Examined Patent Application Publication No. 49-25159

Patent Document 2: Japanese Unexamined Patent Application Publication No. 5-267805

Patent Document 3: Japanese Unexamined Patent Application Publication No. 5-94717

Patent Document 4: Japanese Unexamined Patent Application Publication No. 2002-231052

Patent Document 5: Japanese Unexamined Patent Application Publication No. 2002-365794

Patent Document 6: Japanese Unexamined Patent Application Publication No. 2004-241241

### DISCLOSURE OF INVENTION

Accordingly, it is an object of the present invention to provide an inorganic dielectric powder used for a composite dielectric material, the inorganic dielectric powder having high filling properties and expressing a high dielectric constant when used as a composite dielectric. It is another object of the present invention to provide a composite dielectric material having a high dielectric constant, the composite dielectric material being used for dielectric layers of electronic components, such as printed circuit boards, semiconductor packages, capacitors, antennae for radio frequencies, and inorganic electroluminescent devices.

The inventors have conducted intensive studies to overcome the problems and found that an inorganic dielectric powder containing perovskite compound oxide particles prepared by wet-reaction of a titanium compound and a barium compound with a compound containing a subcomponent and then calcination of the resulting product had satisfactory filling properties to a polymeric material and that a composite dielectric material containing the inorganic dielectric powder had a high dielectric constant. The findings resulted in completion of the present invention.

According to a first aspect of the present invention, in an inorganic dielectric powder used for a composite dielectric material mainly containing a polymeric material and the inorganic dielectric powder, the inorganic dielectric powder includes perovskite compound oxide particles in which a subcomponent element is dissolved in barium titanate particles, wherein the perovskite compound oxide particles are prepared by wet-reaction of a titanium compound and a barium compound with a compound containing the subcomponent element and then calcining the resulting reaction product.

According to a second aspect of the present invention, a composite dielectric material includes a polymeric material and the inorganic dielectric powder according to the first aspect of the present invention.

### BEST MODE FOR CARRYING OUT THE INVENTION

The present invention will be described in detail on the basis of preferred embodiments.

The inorganic dielectric powder for a composite dielectric material is essentially perovskite compound oxide particles containing a subcomponent element dissolved in barium titanate particles, wherein the perovskite compound oxide is prepared by wet-reaction of a titanium compound and a barium compound with a compound containing the subcomponent and then calcination of the resulting product.

That is, the inventive inorganic dielectric powder for a composite dielectric material is a barium titanate-based perovskite compound oxide containing the subcomponent element that is homogeneously present from the surface to the inside of each barium titanate particle compared with a known barium titanate-based inorganic dielectric powder containing a subcomponent element for a composite dielectric material. Furthermore, the inorganic dielectric powder of the present invention is characterized in that the inventive inorganic dielectric powder is formed of unsintered barium titanate-based perovskite compound oxide particles which shows a single phase determined by X-ray diffraction analysis and which is prepared by heat-treatment of calcination alone unlike a known barium titanate-based perovskite sintered ceramic compound oxide prepared by pressure-forming a perovskite compound oxide powder with a binder resin into a compact and then firing the resulting compact at a high temperature to cause sintering and densification.

The inorganic dielectric powder according to the present invention is formed of the perovskite compound oxide particles having the above-described characteristics and thus has satisfactory filling properties. Furthermore, when the inorganic dielectric powder is used for the composite dielectric material, the inorganic dielectric powder can impart satisfactory dielectric properties to the composite dielectric material.

The subcomponent element is at least one element selected from metal elements with an atomic number of 3 or more, metalloid elements, transition metal elements, and rare-earth elements. Among these, the subcomponent element is preferably at least one element selected from rare-earth elements, V, Ca, Bi, Al, W, Mo, Zr, and Nb. The rare-earth element is particularly preferably at least one element selected from Pr, Ce, and La in view that the dielectric constant is further improved compared with a case in which another rare-earth element is used.

The content of the subcomponent element is 0.1 to 20 mol % and preferably 0.5 to 5 mol %. At a content of the subcomponent element below 0.5 mol %, the subcomponent element has a small effect of improving the dielectric constant. On the other hand, a content of the subcomponent element exceeding 20 mol % may result in the formation of a heterogeneous phase against a continuous solid-solution phase and thus is not preferred.

As described above, the perovskite compound oxide particles contained in the inorganic dielectric powder according to the present invention are prepared by wet-reaction of a titanium compound and a barium compound with a compound containing the subcomponent element and then calcination of the resulting product.

In the present invention, examples of the wet-reaction include coprecipitation, hydrolysis, hydrothermal synthesis, and a reaction by heat under atmospheric pressure.

To prepare the inorganic dielectric powder used in the present invention by coprecipitation, the following processes may be employed: a process of adding an alkali, such as caustic soda functioning as a coprecipitating agent, to an aqueous solution containing a titanium compound, a barium compound, and a compound containing a subcomponent element, each compound being a chloride or a hydroxide, to form a hydrated oxide mixture or a hydroxide mixture containing titanium, barium, and the subcomponent element and then calcining the mixture; and a process of adding an organic acid, such as oxalic acid or a citric acid functioning as a coprecipitating agent, to an aqueous solution containing a titanium compound, a barium compound, and a compound containing a subcomponent element, each compound being a chloride or a hydroxide, to form a composite organic acid salt and then calcining the composite organic acid salt. With respect to calcination conditions, the calcination temperature is 400° C. to 1,200° C., preferably 700° C. to 1,100° C., and particularly preferably 1,000° C. to 1,100° C. The calcination time is 2 to 30 hours and preferably 5 to 20 hours.

In the present invention, the term “hydrolysis” means that at least a titanium alkoxide is used and hydrolyzed to perform a reaction. Specifically, the following processes may be employed: for example, (A) a process of hydrolyzing a liquid mixture containing a titanium alkoxide, a barium alkoxide, and an alkoxide of a subcomponent element and then calcining the resulting product; (B) a process of hydrolyzing a titanium alkoxide and an alkoxide of a subcomponent element to prepare a liquid mixture containing titanium and the subcomponent element, adding barium hydroxide to the resulting liquid mixture to perform a reaction, and calcining the resulting product; and (C) a process of adding a titanium alkoxide to an aqueous solution containing a compound having a subcomponent element to prepare a liquid mixture containing titanium and the subcomponent element, adding barium hydroxide to the resulting liquid mixture to perform a reaction, and calcining the resulting product. In process (C), examples of the compound containing the subcomponent element that may be used include water-soluble salts containing the subcomponent element. A solvent, as a component other than the metal alkoxides, constituting the liquid mixture in each of processes (A), (B), and (C) is not particularly limited as long as the solvent is inactive against the metal alkoxides. Examples of the solvent include lower alcohols, such as methanol, ethanol, isopropanol, and n-propanol; aromatic hydrocarbons, such as toluene, xylene, and benzene; nitrites, such as acetonitrile and propionitrile; halogenated aromatic hydrocarbons such as chlorobenzene; and haloalkanes, such as methylene chloride and chloroform. These solvents may be used alone or in combination of two or more.

With respect to calcination conditions in hydrolysis, the calcination temperature is 400° C. to 1,200° C., preferably 700° C. to 1,100° C., and particularly preferably 1,000° C. to 1,100° C. The calcination time is 2 to 30 hours and preferably 5 to 20 hours.

To prepare the inorganic dielectric powder used in the present invention by hydrothermal synthesis, the following process may be employed: a process of adjusting the pH of a mixed solution of a titanium compound such as titanium tetrachloride and a barium compound such as barium chloride to a pH value at which the reaction proceeds, i.e., usually 10 or more, with an alkali to prepare an aqueous alkaline mixed solution, performing a reaction usually at a temperature in the range of 100° C. to 300° C. under pressure, and calcining the resulting product. Specifically, the process includes adding a predetermined amount of a compound, such as an oxide, a hydroxide, a chloride, a nitrate, an acetate, a carbonate, an ammonium salt, or an alkoxide, containing the subcomponent element to the mixed solution of the titanium compound and the barium compound; and calcining the resulting product. With respect to calcination conditions in this case, the calcination temperature is 400° C. to 1,200° C., preferably 700° C. to 1,100° C., and particularly preferably 1,000° C. to 1,100° C. The calcination time is 2 to 30 hours and preferably 5 to 20 hours.

To prepare the inorganic dielectric powder used in the present invention by reaction by heat under atmospheric pressure, the following process may be employed: a process of adjusting the pH of a mixed solution of a titanium compound such as titanium tetrachloride and a barium compound such as barium chloride to a pH value at which the reaction proceeds, i.e., usually 10 or more, with an alkali to prepare an aqueous alkaline mixed solution, boiling the solution to perform a reaction under atmospheric pressure, and calcining the resulting product. Specifically, the process includes adding a predetermined amount of a compound, such as an oxide, a hydroxide, a chloride, a nitrate, an acetate, a carbonate, an ammonium salt, or an alkoxide, containing the subcomponent element to the mixed solution of the titanium compound and the barium compound; and calcining the resulting product. With respect to calcination conditions in this case, the calcination temperature is 400° C. to 1,200° C., preferably 700° C. to 1,100° C., and particularly preferably 1,000° C. to 1,100° C. The calcination time is 2 to 30 hours and preferably 5 to 20 hours.

In the reaction by heat under atmospheric pressure or the hydrolysis, the wet-reaction of the titanium compound and the barium compound with the compound containing the subcomponent element may be performed in the presence of a chelating agent, such as ethylenediaminetetraacetic acid (EDTA), diethyleneamine pentaacetic acid (DTPA), nitrilotriacetic acid (NTA), triethylenetetra hexaacetic acid (TTHA), or trans-1,2-cyclohexanediamine-N,N,N′,N′-tetraacetic acid (CDTA); an ammonium salt thereof, an sodium salt thereof, or an potassium salt thereof; or hydrogen peroxide (see Japanese Unexamined Patent Application Publication No. 5-330824, Colloid and Surface, 32(1988), pp. 257-274).

In the present invention, among these wet-reactions, the perovskite compound oxide prepared by hydrolysis is preferred. In the hydrolysis, in particular, the perovskite compound oxide prepared by process (B) or (C) is preferred because the perovskite compound oxide has a high dielectric constant and can impart particularly satisfactory dielectric properties to the composite dielectric material.

In the inorganic dielectric powder of the present invention, calcination may be repeatedly performed according to need. In order to achieve uniform powder characteristics, the inorganic dielectric powder may be prepared by calcining the reaction product once, pulverizing the resulting calcine, and calcining the pulverized product again.

With respect to another physical property of the inorganic dielectric powder of the present invention, the average particle size determined using a scanning electron micrograph is 4 μm or less and preferably 0.05 to 1 μm. The inorganic dielectric powder having an average particle size within the range reduces aggregation and separation when the powder is dispersed in a resin and is thus preferred.

The inorganic dielectric powder according to the present invention has a BET specific surface area of 0.8 m²/g or more and preferably 2 to 15 m²/g. A BET specific surface area within the range results in the achievement of a high filling level and a reduction in viscosity when the powder is dispersed and is thus preferred.

The shape of each of the perovskite compound oxide particles constituting the inorganic dielectric powder according to the present invention is not particularly limited but may be spherical, granular, plate, scale, whisker, rod, or filament. Spherical particles are particularly preferred in view of the achievement of a high filling level and a reduction in viscosity when the particles are dispersed.

In the inorganic dielectric powder according to the present invention, the inorganic dielectric powders having different particle shapes may be appropriately selected and used in combination of two or more. Furthermore, the inorganic dielectric powders having different average particle sizes may be appropriately combined as long as the average particle size is within the range described above.

A composite dielectric material of the present invention will be described below.

The composite dielectric material contains a polymeric material and the inorganic dielectric powder.

The composite dielectric material has a dielectric constant of 30 or more and preferably 40 or more because the polymeric material described below contains 60 percent by weight or more and preferably 70 to 85 percent by weight of the inorganic dielectric powder.

Examples of the polymeric material usable in the present invention include thermosetting resins, thermoplastic resins, and photosensitive resins.

A known thermosetting resin may be used. Examples thereof include epoxy resins, phenol resins, polyimide resins, melamine resins, cyanate resins, bismaleimide resins, addition polymers of bismaleimides and diamines, polyfunctional cyanate resins, double-bond addition polyphenylene oxide resins, unsaturated polyester resins, poly(vinyl benzyl ether) resins, polybutadiene resins, and fumarate resins. A resin having satisfactory heat resistance after curing is preferably used. These resins may be used alone or as a mixture thereof. However, the thermosetting resin is not limited thereto. Among these thermosetting resins, an epoxy resin is preferred in view of a balance of heat resistance, processability, and cost.

The term “epoxy resin” includes monomers, oligomers, and polymers that have at least two epoxy groups per molecule. Examples of the epoxy resin include phenolic novolac epoxy resins and ortho-cresol novolac epoxy resins, which are each prepared by condensation or co-condensation of an aldehyde, such as formaldehyde, propionaldehyde, benzaldehyde, or salicylaldehyde, and either a phenol, such as phenol, cresol, xylenol, resorcin, catechol, bisphenol A, or bisphenol F, and/or a naphthol, such as α-naphthol, β-naphthol, or dihydroxynaphthalene, in the presence of an acid catalyst, and by epoxidation; diglycidyl ethers of bisphenol A, bisphenol B, bisphenol F, bisphenol S, and unsubstituted or alkyl substituted biphenols; products each prepared by epoxidation of an adduct or a polyadduct of a phenol with dicyclopentadiene or a terpene; glycidyl ester epoxy resins each prepared by reaction of a polybasic acid, such as phthalic acid or dimer acid, with epichlorohydrin; glycidylamine epoxy resins prepared by reaction of a polyamine, such as diaminodiphenylmethane or isocyanuric acid, with epichlorohydrin; and linear aliphatic epoxy resins and alicyclic epoxy resins each prepared by oxidation of olefin bonds with a peracid such as peracetic acid. However, the epoxy resin is not limited thereto. These resins may be used alone or in combination of two or more.

Any one of the epoxy resin curing agents that are known by a person skilled in the art may be used. Examples of the epoxy resin curing agent include C₂ to C₄₀ linear aliphatic diamines, such as ethylenediamine, trimethylenediamine, tetramethylenediamine, and hexamethylenediamine; amines, such as meta-phenylenediamine, para-phenylenediamine, para-xylenediamine, 4,4′-diaminodiphenylmethane, 4,4′-diaminodiphenylpropane, 4,4′-diamino diphenyl ether, 4,4′-diamino diphenyl sulfone, 4,4′-diaminodicyclohexane, bis(4-aminophenyl)phenylmethane, 1,5-diaminonaphthalene, meta-xylylenediamine, para-xylylenediamine, 1,1-bis(4-aminophenyl)cyclohexane, or dicyanodiamide; phenolic novolac resins, such as phenolic novolac resins, cresol novolac resins, tert-butylphenol novolac resins, and nonylphenol novolac resins; resol phenolic resins; polyoxystyrenes such as poly-p-oxystyrene; phenol resins each prepared by co-condensation of a phenol compound, such as a phenol aralkyl resin or naphthol aralkyl resin, in which a hydrogen atom bonded to a benzene ring, a naphthalene ring, or another aromatic ring is replaced with a hydroxy group and a carbonyl compound; and acid anhydride. These may be used alone or in combination of two or more.

The amount of the epoxy resin curing agent incorporated is in the range of 0.1 to 10 and preferably 0.7 to 1.3 in equivalent ratio with respect to the epoxy resin.

In the present invention, to accelerate the curing reaction of the epoxy resin, a known curing accelerator may be used. Examples of the curing accelerator include tertiary amines, such as 1,8-diazabicyclo(5,4,0)undecane-7, triethylenediamine, and benzyldimethylamine; imidazole compounds, such as 2-methylimidazole, 2-ethyl-4-methylimidazole, 2-phenylimidazole, and 2-phenyl-4-methylimidazole; organic phosphine, such as triphenyl phosphine and tributyl phosphine; phosphonium salts; and ammonium salts. These may be used alone or in combination of two or more.

Examples of the thermoplastic resin used in the present invention include known (meth)acrylic resins, hydroxystyrene resins, novolac resins, polyester resins, polyimide resins, nylon resins, and poly(ether-imide) resins.

A known photosensitive resin may be used in the present invention. Examples thereof include photopolymerizable resins and photocrosslinkable resins.

Examples of the photopolymerizable resin include a mixture containing an ethylenically unsaturated group-containing acrylic copolymer (photosensitive oligomer), a photopolymerizable compound (photosensitive monomer), and a photopolymerization initiator; and a mixture containing an epoxy resin and a cationic photopolymerization initiator. Examples of the photosensitive oligomer include a first product of the addition of acrylic acid to an epoxy resin; a product prepared by reaction of the first product with an acid anhydride; a second product prepared by reaction of a copolymer including a glycidyl group-containing (meth)acrylic monomer with (meth)acrylic acid; a product prepared by reaction of the second product with an acid anhydride; a third product prepared by reaction of a copolymer including a hydroxy group-containing (meth)acrylic monomer with glycidyl(meth)acrylate; a product prepared by reaction of the third product with an acid anhydride; a product prepared by reaction of a copolymer containing maleic anhydride with a hydroxy group-containing (meth)acrylic monomer or a glycidyl group-containing (meth)acrylic monomer. These may be used alone or in combination of two or more. However, the photosensitive oligomer is not limited thereto.

Examples of the photopolymerizable compound (photosensitive monomer) include 2-hydroxyethyl (meth)acrylate, 2-hydroxypropyl(meth)acrylate, N-vinylpyrrolidone, acryloylmorpholine, methoxypolyethylene glycol (meth)acrylate, polyethylene glycol di(meth)acrylate, polypropylene glycol di(meth)acrylate, N,N-dimethylacrylamide, phenoxyethyl(meth)acrylate, cyclohexyl (meth)acrylate, trimethylolpropane (meth)acrylate, pentaerythritol tri(meth)acrylate, dipentaerythritol hexa(meth)acrylate, tris(hydroxyethyl)isocyanurate di(meth)acrylate, and tris(hydroxyethyl)isocyanurate tri(meth)acrylate. These may be used alone or in combination of two or more.

Examples of the photopolymerization initiator include benzoin and alkyl ethers thereof; benzophenones; acetophenones; anthraquinones; xanthones; and thioxanthones. These are used alone or in combination. These photopolymerization initiators may be used in combination with known photopolymerization accelerators, such as benzoic acids and tertiary amines. Examples of the cationic photopolymerization initiator include triphenylsulfonium hexafluoroantimonate; diphenylsulfonium hexafluoroantimonate; triphenylsulfonium hexafluorophosphate; benzyl-4-hydroxyphenylmethylsulfonium hexafluorophosphate; and a salt of a Brönsted acid and an iron aromatic compound (CG24-061, from Ciba-Geigy). These may be used alone or in combination of two or more.

The epoxy resin undergoes ring-opening polymerization with the cationic photopolymerization initiator. With respect to photopolymerizability, the alicyclic epoxy resin has a higher reaction rate than a usual glycidyl ester epoxy resin and is thus more preferred. The alicyclic epoxy resin may be used in combination with the glycidyl ester epoxy resin. Examples of the alicyclic epoxy resin include vinylcyclohexene diepoxide, alicyclic diepoxy acetals, alicyclic diepoxy adipate, alicyclic diepoxy carboxylate, and EHPE-3150 manufactured by Daicel Chemical Industries, Ltd. These may be used alone or as a mixture.

Examples of the photocrosslinkable resin include a water-soluble polymer containing a bichromate; polyvinyl cinnamate (KPR, from Kodak); and a cyclized rubber containing an azide (KTFR, from Kodak). These may be used alone or in combination of two or more. However, the photocrosslinkable resin is not limited thereto.

In general, these photosensitive resins each have a dielectric constant as low as 2.5 to 4.0. To increase the dielectric constant of the binder, a high-dielectric polymer (for example, SDP-E manufactured by Sumitomo Chemical Co., Ltd., (ε: 15<), Cyanoresin manufactured by Shin-Etsu Chemical Co., Ltd. (ε: 18<)) and a high-dielectric liquid (for example, SDP-S manufactured by Sumitomo Chemical Co., Ltd., (ε: 40<)) may be added within the range in which the photosensitivity of the photosensitive resin is not impaired.

In the present invention, the above-described polymeric materials may be used alone or in combination of two or more.

In the composite dielectric material of the present invention, the amount of the inorganic dielectric powder incorporated is 150 to 1,800 parts by weight and preferably 300 to 600 parts by weight with respect to 100 parts by weight of the resin solid content. An amount of the inorganic dielectric powder of less than 300 parts by weight is undesired because there is a tendency not to achieve a sufficient dielectric constant. An amount of the inorganic dielectric powder of more than 600 parts by weight is also undesired because there is a tendency to increase the viscosity to degrade dispersibility, and a solidified composite may have insufficient strength.

Furthermore, the composite dielectric material of the present invention may contain a filler in an amount within the range in which the effect of the present invention is not impaired. Examples of the filler usable include fine carbon powders, such as acetylene black and Ketjenblack; fine graphite powder; and silicon carbide.

The composite dielectric material of the present invention may further contain a compound other than the above-described compounds. Examples of the compound other than the above-described compounds include curing agents, coupling agents, polymeric additives, reactive diluents, polymerization inhibitors, leveling agents, wettability-improving agents, surfactants, plasticizers, ultraviolet absorbers, antioxidants, antistatic agents, inorganic fillers, mildewproofing agents, moisture-controlling agents, dye-dissolving agents, buffers, chelating agents, flame retardants, and silane coupling agents. These additives may be used alone or in combination of two or more.

The composite dielectric material of the present invention may be formed by preparing a composite dielectric paste, removing a solvent, and performing curing or polymerization.

The composite dielectric paste contains a resin component, the inorganic dielectric powder, an additive optionally added, and an organic solvent optionally added.

The resin component contained in the dielectric paste is a polymerizable compound for forming a thermosetting resin, a polymer for forming a thermoplastic resin, or a polymerizable compound for forming a photosensitive resin. The resin component may be used alone or as a mixture.

The term “polymerizable compound” refers to a polymerizable group-containing compound. Examples thereof include polymeric precursors, polymerizable oligomers, and monomers, before complete curing. The term “polymer” refers to a compound in which a polymerization reaction has been substantially completed.

The organic solvent added according to need varies in response to the resin component used and is not limited as long as the organic solvent dissolves the resin component. Examples of the organic solvent include N-methylpyrrolidone; dimethylformamide; ethers, such as diethyl ether, tetrahydrofuran, dioxane, ethyl glycol ether, which is a monoalcohol, having 1 to 6 carbon atoms and having an optionally branched alkyl group, propylene glycol ether, butyl glycol ether; ketones such as acetone, methyl ethyl ketone, methyl isopropyl ketone, methyl isobutyl ketone, and cyclohexanone; esters, such as ethyl acetate, butyl acetate, ethylene glycol acetate, methoxypropyl acetate, and methoxypropanol; halogenated hydrocarbons; aliphatic hydrocarbons; and aromatic hydrocarbons. Among these, hexane, heptane, cyclohexane, toluene, or dixylene may be used. These may be used alone or as a mixture.

In the present invention, the composite dielectric paste is adjusted so as to have a target viscosity and is then used. The viscosity of the composite dielectric paste is in the range of 1,000 to 1,000,000 mPa·s (25° C.) and preferably 10,000 to 600,000 mPa·s (25° C.). The viscosity within the range above is desirable because the composite dielectric paste has satisfactory application properties.

The composite dielectric material can be formed into a film, a bulk, or a formed article having a predetermined shape and can then be used. In particular, the composite dielectric material can be used as a high-dielectric thin film.

For example, a composite dielectric film composed of the composite dielectric material of the present invention may be produced according to a known process of using a composite dielectric paste. An exemplary process is described below.

The composite dielectric paste is applied on a base and dried into a film. An example of the base is a plastic film having a surface subjected to release treatment. When the composite dielectric paste is applied on the plastic film subjected to release treatment to form a film, generally, it is preferred that the film be detached from the base after the film formation and be then used. Examples of the plastic film that can be used as the base include poly(ethylene terephthalate) (PET) films, polyethylene films polypropylene films, polyester films, polyimide films, aramid films, Kapton films, polymethylpentene films. The plastic film used as the base preferably has 1 to 100 μm and more preferably 1 to 40 μm. With respect to the release treatment to which a surface of the base is subjected, it is preferred to employ release treatment in which a silicone, wax, a fluorocarbon resin, or the like is applied to the surface.

Alternatively, metal foil may be used as the base, and the dielectric film may be formed on the metal foil. In this case, the metal foil serving as the base can be used as an electrode of a capacitor.

A process of applying the composite dielectric paste on the base is not limited. A common application process may be employed. For example, the paste may be applied by a roller method, a spray method, or a silk-screen method.

Such a dielectric film can be incorporated in a substrate, such as a printed circuit board, and then cured by heating. When a photosensitive resin is used, the film can be patterned by selective exposure.

Furthermore, for example, the composite dielectric material of the present invention may be extruded and calendered into a film.

The composite dielectric paste may be extruded on the base to form a film. Examples of the metal foil used as the base include foils each composed of copper, aluminum, brass, nickel, iron, or the like, foils composed of alloys thereof, and composite foils. The metal foil may be subjected to surface-roughening treatment and application of an adhesive, according to need.

The dielectric film may be formed between the metal foils. In this case, after the composite dielectric paste is applied on the metal foil, a metal foil is placed on the paste. Drying is performed while the composite dielectric paste is disposed between the metal foils. Thereby, the dielectric film may be formed between the metal foils. Alternatively, the dielectric film disposed between the metal foils may be formed by extruding the composite dielectric paste between the metal foils.

The composite dielectric material has a high dielectric constant and thus can be suitably used for dielectric layers in electronic components, such as printed circuit boards, semiconductor packages, capacitors, radio-frequency antennae, and inorganic electroluminescent components.

### EXAMPLES

The present invention will be described in detail by way of examples. However, the present invention is not limited thereto.

### Example 1

First, 44.1 g of a 0.5 mol/kg niobium ethoxide solution in toluene was added to 750 g of titanium butoxide. The resulting solution was stirred to form a complex alkoxide loading solution. Into a 10-L reaction vessel, 2,500 g of water is charged. The complex alkoxide solution was gradually added dropwise to water under stirring to be subjected to hydrolysis, thereby resulting in a suspension. A solution prepared by addition of 975 g of barium hydroxide octahydrate to 3,000 g of water and dissolution at 80° C. was added dropwise to the suspension. The vessel was heated to 90° C. at a heating rate of 10° C./h and maintained at 90° C. for 1 hour. Then, heating and stirring were stopped, and the vessel was cooled. A Buchner funnel was attached to a filtrating flask. Solid-liquid separation was performed under suction using an aspirator. The resulting prepared powder had a barium-rich composition. Thus, the powder was washed with an aqueous solution containing acetic acid so as to have a barium to titanium molar ratio in the range of 1.000 to 0.005. Then, solid-liquid separation was performed again. The resulting cake was dried at 120° C. for 8 hours or more. The resulting dried powder was disintegrated with a mortar and was calcined at 1,100° C. for 4 hours. Agglomerates present in the drying step and heat treatment step were removed by ball milling. Into a 700-mL vessel, 1,100 g of ZrO₂ balls each having a diameter of 5 mm, 100 g of ethanol as a solvent, and 30 g of the heat-treated powder were charged. After sealing, disintegration was performed at 100 rpm for 2 hours. After the completion of the disintegration, the total mixture including the balls was dried. The mixture was sifted to separate a powder from the balls. The resulting powder was further disintegrated with the mortar to prepare a sample.

With respect to the composition of the resulting composite perovskite sample, the barium (Ba) to titanium (Ti) molar ratio, i.e., Ba/Ti, was determined by a glass bead method using X-ray fluorescence and found to be 1.002. The niobium (Nb) content was measured by ICP-AES and calculated to be 0.93 mol % relative to barium titanate.

The resulting X-ray diffraction pattern of the sample powder showed a single-phase perovskite structure. The results demonstrated that niobium was completely dissolved in barium titanate. The average particle size calculated from a scanning electron micrograph was 0.48 μm. The specific surface area was 3.43 m²/g.

### Example 2

Into a 10-L reaction vessel, 2,500 g of water was charged. Then, 2.6 g of ammonium vanadate was added thereto. The mixture was stirred to prepare a solution. Under stirring the solution, 750 g of titanium butoxide was gradually added dropwise to the solution to be subjected to hydrolysis, resulting in a suspension. The vessel was heated to 90° C. at a heating rate of 10° C./h and maintained at 90° C. for 1 hour. Then, heating and stirring were stopped, and the vessel was cooled. A Buchner funnel was attached to a filtrating flask. Solid-liquid separation was performed under suction using an aspirator. The resulting prepared powder had a barium-rich composition. Thus, the powder was washed with an aqueous solution containing acetic acid so as to have a barium to titanium molar ratio in the range of 1.000 to 0.005. Then, solid-liquid separation was performed again. The resulting cake was dried at 120° C. for 8 hours or more. The resulting dried powder was disintegrated with a mortar and was calcined at 1,100° C. for 4 hours. Agglomerates present in the drying step and heat treatment step were removed by ball milling. Into a 700-mL vessel, 1,100 g of ZrO₂ balls each having a diameter of 5 mm, 100 g of ethanol as a solvent, and 30 g of the heat-treated powder were charged. After sealing, disintegration was performed at 100 rpm for 2 hours. After the completion of the disintegration, the total mixture including the balls was dried. The mixture was sifted to separate a powder from the balls. The resulting powder was further disintegrated with the mortar to prepare a sample.

With respect to the composition of the resulting composite perovskite sample, the barium (Ba) to titanium (Ti) molar ratio, i.e., Ba/Ti, was determined by a glass bead method using X-ray fluorescence and found to be 1.005. The niobium (Nb) content was measured by ICP-AES and calculated to be 0.90 mol % relative to barium titanate.

The resulting X-ray diffraction pattern of the sample powder showed a single-phase perovskite structure. The results demonstrated that vanadium was completely dissolved in barium titanate. The average particle size calculated from a scanning electron micrograph was 0.62 μm. The specific surface area was 2.43 m²/g.

### Example 3

Into a 10-L reaction vessel, 1,000 g of water was charged, and 9 g of calcium chloride dihydrate was added thereto to prepare a solution. A liquid mixture containing 715 g of titanium butoxide and 175 g of zirconium butoxide were gradually added thereto to hydrolyze the butoxides, resulting in a suspension. To the suspension, a solution prepared by addition of 1,250 g of barium hydroxide octahydrate to 2,500 g of water and then dissolution at 80° C. was added dropwise. The vessel was heated to 90° C. at a heating rate of 30° C./h and maintained at 90° C. for 1 hour. Then, heating and stirring were stopped, and the vessel was cooled. A Buchner funnel was attached to a filtrating flask. Solid-liquid separation was performed under suction using an aspirator. The resulting prepared powder had a barium-rich composition. Thus, the powder was washed with an aqueous solution containing acetic acid so as to have a ratio of the total number of moles of barium and calcium to the total number of moles of titanium and zirconium in the range of 1.000 to 0.005. Then, solid-liquid separation was performed again. The resulting cake was dried at 120° C. for 8 hours or more. The resulting dried powder was disintegrated with a mortar and was calcined at 900° C. for 4 hours. Agglomerates present in the drying step and heat treatment step were removed by ball milling. To a 700-mL vessel, 1,100 g of ZrO₂ balls each having a diameter of 5 mm, 100 g of ethanol as a solvent, and 30 g of the heat-treated powder were charged. After sealing, disintegration was performed at 100 rpm for 2 hours. After the completion of the disintegration, the total mixture including the balls was dried. The mixture was sifted to separate a powder from the balls. The resulting powder was further disintegrated with the mortar to prepare a sample.

The composition of the resulting composite perovskite sample was determined by a glass bead method using X-ray fluorescence. The results demonstrated that the composite perovskite sample contained 49.46 mol % Ba, 0.55 mol % Ca, 42.02 mol % Ti, and 7.97 mol % Zr. The ratio of the total number of moles (Ba+Ca) of barium (Ba) and calcium (Ca) to the total number of moles of titanium (Ti) and zirconium (Zr), i.e., ((Ba+Ca)/(Ti+Zr)), was 1.001.

The resulting X-ray diffraction pattern of the sample powder showed a single-phase perovskite structure. The results demonstrated that the four components were completely dissolved to form a solid solution. The average particle size calculated from a scanning electron micrograph was 0.18 μm. The specific surface area was 8.62 m²/g.

### Example 4

A composite perovskite sample was prepared as in EXAMPLE 2, except that 9.1 g of praseodymium acetate dihydrate was used in place of ammonium vanadate. With respect to the composition of the resulting composite perovskite sample, the barium (Ba) to titanium (Ti) molar ratio, i.e., Ba/Ti, was determined by a glass bead method using X-ray fluorescence and found to be 1.003. The praseodymium content was measured by ICP-AES and calculated to be 0.98 mol % relative to barium titanate.

The resulting X-ray diffraction pattern of the sample powder showed a single-phase perovskite structure. The results demonstrated that praseodymium was completely dissolved in barium titanate. The average particle size calculated from a scanning electron micrograph was 0.47 μm. The specific surface area was 2.94 m²/g.

### Example 5

A composite perovskite sample was prepared as in EXAMPLE 2, except that 8.1 g of cerium acetate monohydrate was used in place of ammonium vanadate. With respect to the composition of the resulting composite perovskite sample, the barium (Ba) to titanium (Ti) molar ratio, i.e., Ba/Ti, was determined by a glass bead method using X-ray fluorescence and found to be 1.005. The cerium content was measured by ICP-AES and calculated to be 0.96 mol % relative to barium titanate.

The resulting X-ray diffraction pattern of the sample powder showed a single-phase perovskite structure. The results demonstrated that praseodymium was completely dissolved in barium titanate. The average particle size calculated from a scanning electron micrograph was 0.56 μm. The specific surface area was 2.40 m²/g.

### Example 6

A composite perovskite sample was prepared as in EXAMPLE 2, except that 9.0 g of lanthanum chloride heptahydrate was used in place of ammonium vanadate. With respect to the composition of the resulting composite perovskite sample, the barium (Ba) to titanium (Ti) molar ratio, i.e., Ba/Ti, was determined by a glass bead method using X-ray fluorescence and found to be 1.002. The cerium content was measured by ICP-AES and calculated to be 0.97 mol % relative to barium titanate.

The resulting X-ray diffraction pattern of the sample powder showed a single-phase perovskite structure. The results demonstrated that lanthanum was completely dissolved in barium titanate. The average particle size calculated from a scanning electron micrograph was 0.50 μm. The specific surface area was 2.77 m²/g.

### Comparative Example 1

Into a 700-mL pot, 71.2 g of barium carbonate (specific surface area: 3.35 m²/g), 28.8 g of titanium oxide (specific surface area 6.70 m²/g), 150 g ethanol as a solvent, and 1,100 g of ZrO₂ balls as a media each having a diameter of 5 mm were charged. Dispersion and mixing were made by ball milling for 10 hours. The whole mixture was dried and sifted to separate a dry powder from the media and. Thereby, the dry powder was prepared. The dry powder was calcined at 900° C. for 4 hours. Agglomerates present in the drying step and heat treatment step were removed by ball milling. Into a 700-mL vessel, 1,100 g of ZrO₂ balls each having a diameter of 5 mm, 100 g of ethanol as a solvent, and 30 g of the heat-treated powder were charged. After sealing, disintegration was performed at 100 rpm for 2 hours. After the completion of the disintegration, the total mixture including the balls was dried. The mixture was sifted to separate a powder from the balls. The mixture was sifted to separate a powder from the balls. The resulting powder was further disintegrated with a mortar to prepare a sample.

With respect to the composition of the resulting barium titanate sample, the barium (Ba) to titanium (Ti) molar ratio, i.e., Ba/Ti, was determined by a glass bead method using X-ray fluorescence and found to be 0.999. The average particle size calculated from a scanning electron micrograph was 0.30 μm. The specific surface area was 4.04 m²/g.

### Comparative Example 2

Barium titanate was prepared as in EXAMPLE 2, except that ammonium vanadate was not added, and the calcination temperature was set at 900° C.

With respect to the composition of the resulting barium titanate sample, the barium (Ba) to titanium (Ti) molar ratio, i.e., Ba/Ti, was determined by a glass bead method using X-ray fluorescence and found to be 1.002. The average particle size calculated from a scanning electron micrograph was 0.58 μm. The specific surface area was 2.64 m²/g.

### Comparative Example 3

Commercially available barium titanate produced by an oxalate method. With respect to the composition of this barium titanate, the barium (Ba) to titanium (Ti) molar ratio, i.e., Ba/Ti, was determined by a glass bead method using X-ray fluorescence and found to be 1.003. The average particle size calculated from a scanning electron micrograph was 0.46 μm. The specific surface area was 3.64 m²/g.

### Comparative Example 4

First, 3 g of a 10 wt % polyvinyl alcohol in water was added to 30 g of barium titanate produced by an oxalate method used in COMPARATIVE EXAMPLE 3. Granulation was performed while mixing the mixture in a mortar. The mixture was sifted with a screen having an opening of 250 μm to prepare a granulated powder. The powder was dried at 105° C. for 2 hours to remove water. The dry powder was pressed with a die at a pressure of 1 t in the uniaxial direction into a formed article having a thickness of about 0.5 mm. The formed article was heated at 1,300° C. for 2 hours to form a ceramic. Coarse crushing was performed in a mortar. The resulting powder obtained by coarse crushing was subjected to wet grinding with a ball mill. Into a 700-mL vessel, 1,100 g of ZrO₂ balls each having a diameter of 5 mm, 100 g of ethanol as a solvent, and 20 g of the heat-treated powder were charged. After sealing, the mixture was disintegrated at 100 rpm for 5 hours. After the disintegration, the total mixture including the balls was dried and sifted with a screen having an opening of 250 μm to separate a powder from the balls, thereby resulting in a sample. The sample was analyzed using a laser. The results demonstrated that the average particle size D50 was 0.66 μm, and the specific surface area was 6.65 m²/g.

### Comparative Example 5

Into a 10-L reaction vessel, 2,500 g of water was charged, and 750 g of titanium butoxide was gradually added dropwise under stirring to perform hydrolysis. Then, a solution prepared by addition of 975 g of barium hydroxide octahydrate to 3,000 g of water and dissolution at 80° C. was added dropwise to the suspension. The vessel was heated to 90° C. at a heating rate of 10° C./h and maintained at 90° C. for 1 hour. Then, heating and stirring were stopped, and the vessel was cooled. A Buchner funnel was attached to a filtrating flask. Solid-liquid separation was performed under suction using an aspirator. The resulting prepared powder had a barium-rich composition. Thus, the powder was washed with an aqueous solution containing acetic acid so as to have a barium to titanium molar ratio in the range of 1.050 to 0.005. Then, solid-liquid separation was performed again. The resulting cake was dispersed in 1,000 g of water and heated to 60° C. A solution containing 26 g of aluminum nitrate nonahydrate dissolved in 200 g of water was added dropwise thereto. The resulting mixture was stirred for 1 hour while maintaining the temperature at 60° C. to coat the surface with aluminum. A Buchner funnel was attached to a filtrating flask. Solid-liquid separation was performed under suction using an aspirator. The resulting cake was dried at 120° C. for 8 hours or more. After disintegration with a mortar, the resulting powder was calcined at 1,100° C. for 4 hours. Agglomerates present in the drying step and heat treatment step were removed by ball milling. Into a 700-mL vessel, 1,100 g of ZrO₂ balls each having a diameter of 5 mm, 100 g of ethanol as a solvent, and 30 g of the heat-treated powder were charged. After sealing, disintegration was performed at 100 rpm for 2 hours. After the completion of the disintegration, the total mixture including the balls was dried. The mixture was sifted to separate a powder from the balls. The resulting powder was further disintegrated with the mortar to prepare a sample.

With respect to the composition of the resulting composite perovskite sample, the barium (Ba) to titanium (Ti) molar ratio, i.e., Ba/Ti, was determined by a glass bead method using X-ray fluorescence and found to be 1.001. The aluminum content was measured by ICP-AES and calculated to be 2.96 mol % relative to barium titanate.

The resulting X-ray diffraction pattern of the sample powder showed a single-phase perovskite structure. The results demonstrated that aluminum was completely dissolved in barium titanate in the vicinity of the surface. The average particle size calculated from a scanning electron micrograph was 0.50 μm. The specific surface area was 3.04 m²/g.

TABLE 1

| | | Type | | | BET |
|---|---|---|---|---|---|
| | | of | | Average | specific |
| | | ele- | | particle | surface |
| | Synthesis | ment | Particle | size | area |
| | method | added | shape | (μm) | (m²/g) |
| EXAMPLE 1 | Hydrolysis | Nb | Spherical | 0.48 | 3.43 |
| EXAMPLE 2 | Hydrolysis | V | Spherical | 0.62 | 2.43 |
| EXAMPLE 3 | Hydrolysis | Ca, | Spherical | 0.18 | 8.26 |
| | | Zr | | | |
| EXAMPLE 4 | Hydrolysis | Pr | Spherical | 0.47 | 2.94 |
| EXAMPLE 5 | Hydrolysis | Ce | Spherical | 0.56 | 2.4 |
| EXAMPLE 6 | Hydrolysis | La | Spherical | 0.5 | 2.77 |
| COMPARATIVE | Solid-phase | — | Indefinite | 0.3 | 4.04 |
| EXAMPLE 1 | method | | | | |
| COMPARATIVE | Hydrolysis | — | Spherical | 0.58 | 2.64 |
| EXAMPLE 2 | | | | | |
| COMPARATIVE | Coprecipitation | — | Indefinite | 0.4 | 3.64 |
| EXAMPLE 3 | | | | | |
| COMPARATIVE | Grinding after | — | Indefinite | 0.66 | 6.65 |
| EXAMPLE 4 | sintering | | | | |
| COMPARATIVE | Hydrolysis | Al | Spherical | 0.5 | 3.04 |
| EXAMPLE 5 | | | | | |

Note:
In the “particle shape” column in Table 1, the particle shapes are determined using the scanning electron micrograph. Particles in the form of substantial spheres are defined as “spherical”. Particles in other shapes are defined as “indefinite”.

### Examples 7 to 12 and Comparative Examples 6 to 11

<Preparation of Composite Dielectric Material>

Epoxy resin compositions shown in Tables 2 and 3 were prepared using the inorganic dielectric powder samples prepared in EXAMPLES 1 to 6 and COMPARATIVE EXAMPLES 1 to 5.

A thermosetting epoxy resin (trade name: Epicoat 815, molecular weight: about 330, specific gravity: 1.1, and nominal viscosity at 25° C.: 9 to 12 P, manufactured by Japan Epoxy Resins Co., Ltd.) was used as the resin. Furthermore, lisobutyl2methylimidazole was used as a curing accelerator. The curing accelerator had a nominal viscosity of 4 to 12 P at 25° C.

Each inorganic dielectric powder was kneaded with the epoxy resin using a mixer having a defoaming function (trade name: “Awatori Rentaro”, manufactured by THINKY Corporation). With respect to the kneading time, a stirring operation was performed for 5 minutes, and a defoaming operation was performed for 5 minutes.

<Evaluation of Composite Dielectric Material>

A Viton O-ring was placed on a plastic substrate. The above-prepared composite dielectric material was poured in the ring. A plastic plate was placed on the top. Curing was performed at 120° C. for 30 minutes in a dryer to form a evaluation disc sample. The O-ring had a cross-sectional diameter of 1.5 mm and an inner diameter of 11 mm. Thus, the sample had an effective thickness of about 1.5 mm and effective diameter of about 10 mm.

To measure the electrical characteristics by a parallel plate method, electrodes were formed on surfaces of the disc. One electrode having a thickness of 20 nm was formed on one surface by evaporation of platinum using a mask having a diameter of 6 mm. The other electrode having a thickness of 20 nm was formed on the other surface by evaporation of platinum.

In the composite dielectric sample with the electrodes, insulation resistance was measured. A dielectric constant and dielectric loss were measured at 25° C. Tables 2 and 3 show the results.

The electrical characteristics were measured with an LCR meter at a frequency of 1 kHz and a signal voltage of 1 V. The sample was placed in a temperature-regulated chamber. The electrical characteristics were measured in the temperature range of −55° C. to 150° C. Table 3 also shows results of a comparative sample, which is prepared by curing a resin alone and indicated as COMPARATIVE EXAMPLE 11.

TABLE 2

| | | | | EXAMPLE | EXAMPLE | EXAMPLE |
|---|---|---|---|---|---|---|
| | EXAMPLE 7 | EXAMPLE 8 | EXAMPLE 9 | 10 | 11 | 12 |
| Epoxy resin | 3 | 3 | 3 | 3 | 3 | 3 |
| (part by weight) | | | | | | |
| Curing | 0.24 | 0.24 | 0.2 | 0.24 | 0.24 | 0.24 |
| accelerator | | | | | | |
| (part by weight) | | | | | | |
| Type of | | | | | | |
| inorganic | | | | | | |
| dielectric | EXAMPLE 1 | EXAMPLE 2 | EXAMPLE 3 | EXAMPLE 4 | EXAMPLE 5 | EXAMPLE 6 |
| Amount of | 9 | 9 | 7 | 9 | 9 | 9 |
| inorganic | | | | | | |
| dielectric | | | | | | |
| blended (part by | | | | | | |
| weight) | | | | | | |
| Ratio of | 75 | 75 | 70 | 75 | 75 | 75 |
| inorganic | | | | | | |
| dielectric | | | | | | |
| blended | | | | | | |
| (percent by | | | | | | |
| weight) | | | | | | |
| Insulation | 2.9 | 3.51 | 2.09 | >100 | >100 | 4.59 |
| resistance Ω | | | | | | |
| (×10¹³) | | | | | | |
| Dielectric | 40 | 44.2 | 30.3 | 39.4 | 39.9 | 39.7 |
| constant | | | | | | |
| Dielectric loss | 1.23 | 2.73 | 1.57 | 1.93 | 1.71 | 1.92 |
| (%) | | | | | | |

TABLE 3

| | | | | | COMPARATIVE | COMPARATIVE |
|---|---|---|---|---|---|---|
| | COMPARATIVE | COMPARATIVE | COMPARATIVE | COMPARATIVE | EXAMPLE | EXAMPLE |
| | EXAMPLE 6 | EXAMPLE 7 | EXAMPLE 8 | EXAMPLE 9 | 10 | 11 |
| Epoxy resin | 3 | 3 | 3 | 3 | 3 | 3 |
| (part by | | | | | | |
| weight) | | | | | | |
| Curing | 0.24 | 0.24 | 0.2 | 0.24 | 0.24 | 0.24 |
| accelerator | | | | | | |
| (part by | | | | | | |
| weight) | | | | | | |
| Type of | | | | | | |
| inorganic | COMPARATIVE | COMPARATIVE | COMPARATIVE | COMPARATIVE | COMPARATIVE | |
| dielectric | EXAMPLE 1 | EXAMPLE 2 | EXAMPLE 3 | EXAMPLE 4 | EXAMPLE 5 | — |
| Amount of | 9 | 9 | 9 | 9 | 9 | — |
| inorganic | | | | | | |
| dielectric | | | | | | |
| blended (part | | | | | | |
| by weight) | | | | | | |
| Ratio of | 75 | 75 | 75 | 75 | 75 | — |
| inorganic | | | | | | |
| dielectric | | | | | | |
| blended | | | | | | |
| (percent by | | | | | | |
| weight) | | | | | | |
| Insulation | 1.65 | 4.33 | 0.87 | 8 | 0.03 | >100 |
| resistance Ω | | | | | | |
| (× 10¹³) | | | | | | |
| Dielectric | 30.9 | 31.1 | 29.4 | 31.1 | 38.4 | 6.8 |
| constant | | | | | | |
| Dielectric | 3.6 | 2.8 | 3.01 | 1.4 | 1.38 | 1.67 |
| loss (%) | | | | | | |

From the results shown in Tables 2 and 3, in each composite of barium titanate consisting of barium and titanium alone with the resin, the dielectric constant was 29 to 31 at a filling rate of 75 wt % and was little affected by the production process (COMPARATIVE EXAMPLES 6, 7, and 9). In contrast, each dielectric powder sample (in each of EXAMPLES 1 to 6) in which the additive of the present invention was dissolved had a greater dielectric constant than pure barium titanate. That is, the results demonstrated that the dielectric properties were improved by 12% at a minimum and by a maximum of 47%. Even in the powder sample with a filling rate of 70 wt % in EXAMPLE 9, the dielectric constant was comparable or more than those of the samples each having a filling rate of 75 wt % in COMPARATIVE EXAMPLES. The results demonstrated that the dielectric properties were substantially improved.

### INDUSTRIAL APPLICABILITY

An inorganic dielectric powder used for a composite dielectric material has high filling properties and expressing a high dielectric constant when used as a composite. The composite dielectric material containing the inorganic dielectric powder has a high dielectric constant and suitably used for dielectric layers of electronic components, such as printed circuit boards, semiconductor packages, capacitors, antennae for radio frequencies, and inorganic electroluminescent devices.

1. An inorganic dielectric powder used for a composite dielectric material mainly containing a polymeric material and the inorganic dielectric powder, the inorganic dielectric powder comprising perovskite compound oxide particles in which a subcomponent element is dissolved in barium titanate particles, wherein the perovskite compound oxide particles are prepared by wet-reaction of a titanium compound and a barium compound with a compound containing the subcomponent element and then calcining the resulting reaction product.

2. The inorganic dielectric powder used for the composite dielectric material according to claim 1, wherein the product formed by wet-reaction is a product formed by hydrolysis of a titanium alkoxide and an alkoxide of the subcomponent element to prepare a liquid mixture containing titanium and the subcomponent element and then by addition of barium hydroxide to the liquid mixture.

3. The inorganic dielectric powder used for the composite dielectric material according to claim 1, wherein the product formed by wet-reaction is a product formed by addition of a titanium alkoxide to an aqueous solution of a compound containing the subcomponent element to prepare a liquid mixture containing titanium and the subcomponent element and then by addition of barium hydroxide to the liquid mixture.

4. The inorganic dielectric powder used for the composite dielectric material according to claim 1, wherein the subcomponent element is at least one element selected from rare-earth elements, V, Ca, Bi, Al, W, Mo, Zr, and Nb.

5. The inorganic dielectric powder used for the composite dielectric material according to claim 4, wherein the rare-earth element is at least one element selected from Pr, Ce, and La.

6. The inorganic dielectric powder used for the composite dielectric material according to claim 1, wherein the content of the subcomponent element is 0.1 to 20 mol %.

7. The inorganic dielectric powder used for the composite dielectric material according to claim 1, wherein the average particle size is 4 μm or less.

8. The inorganic dielectric powder used for the composite dielectric material according to claim 1, wherein the BET specific surface area is 0.8 m²/g or more.

9. A composite dielectric material comprising:
a polymeric material and an inorganic dielectric powder, the inorganic dielectric powder comprising perovskite compound oxide particles having a subcomponent element dissolved in barium titanate particles.

10. The composite dielectric material according to claim 9, wherein the content of the inorganic dielectric powder is 60 percent by weight or more.

11. The composite dielectric material according to claim 9, wherein the dielectric material has a dielectric constant of at least 30.

12. A process for making an inorganic dielectric powder for use in a composite dielectric material comprising a polymeric material and the inorganic dielectric powder, said process comprising the steps of:
wet-reacting a titanium compound and a barium compound with a compound containing a subcomponent element to form a reaction product; and
calcining the reaction product to form the inorganic dielectric powder comprising perovskite compound oxide particles having the subcomponent element dissolved in barium titanate particles.
